(19) United States
(12) Patent Application Publication
(10) Pub. No.: US 2007/0206175 A1
(43) Pub. Date: Sep. 6, 2007

(54) Range finder integrated digital camera

(76) Inventors: Barinder Singh Rai, Surrey (CA); Phil Van Dyke, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/367,059

(22) Filed: Mar. 3, 2006

(51) Int. Cl. G01C 3/08; G06K 9/00

(52) U.S. Cl. 356/4.03; 382/106

(57) ABSTRACT

A method for determining a distance to an object is described. In the method, a size of the object is determined, and an electronic image of the object is captured and displayed on a display device. The size of the image of the object is determined. The distance to the object is calculated using the size of the object, a focal length of the imaging module, and the size of the image of the object. The distance to the object is then displayed on the display device. An imaging device and graphics controller having range-finding functionality are also described.

### BACKGROUND

Battery operated imaging devices having an image sensor and graphical display are increasingly popular. Cell phones and personal data assistants, as well as stand alone digital cameras, are a few examples of such devices incorporating a digital imaging device and electronic display.

As more such devices enter the market, it is increasingly important to provide increased capability and functionality to provide distinguishing features. Unfortunately, many functional improvements require additional hardware accessories, which adversely affect the size, power consumption, and price of the imaging device. It would therefore be desirable to provide enhanced functionality without significantly affecting the cost of production.

Range finders are very popular among certain sporting enthusiasts, including hunters, golfers, and others. Range finders typically include an optical device with which the user can target a certain object, and some additional device to determine the distance to the target. Various range finders on the market use sonar, laser, or radar to determine the distance to the target by calculating the time it takes for a signal to reach the object and reflect back to the range finder. While quite accurate, advanced range finders are quite expensive. It would be desirable to incorporate a range finder having acceptable accuracy into a handheld imaging device without significantly affecting the cost of the device.

### SUMMARY

Broadly speaking, the present invention fills these needs by providing a graphics controller and imaging device having range-finding functionality. It should be appreciated that the present invention can be implemented in numerous ways, including as a process, an apparatus, a system, a device, or a method. Several inventive embodiments of the present invention are described below.

In one embodiment, a method for determining a distance to an object is described. In the method, a size of the object is determined, and an electronic image of the object is captured and displayed on a display device. The size of the image of the object is determined. The distance to the object is calculated using the size of the object, a focal length of the imaging module, and the size of the image of the object. The distance to the object is then displayed on the display device.

In another embodiment, a graphics controller is provided for calculating a distance to an object. The graphics controller includes a camera interface receiving images from an imaging module, a display interface for displaying an image on a display, a host interface for interfacing with a host CPU, a plurality of registers, and distance calculation logic. The distance calculation logic calculates the distance to the object from operands stored in the plurality of registers. The distance to the object is stored back into one of the plurality of registers. The operands include a size of the object and a size of the image of the object.

In yet another embodiment, a device for determining a distance to an object is provided. The device includes an imaging module, an electronic display for displaying an electronic image, a user input device, a host CPU in communication with user input device, and a graphics controller. The imaging module has a lens and an image sensor, the lens focusing an image onto the image sensor. The graphics controller includes a camera interface receiving images from the imaging module, a display interface for displaying an image on the display, a host interface for interfacing with the host CPU, a plurality of registers, and distance calculation logic. The distance calculation logic calculates the distance to the object from operands stored in the plurality of registers, and stores the distance to the object back into one of the plurality of registers. The operands include a size of the object, and a size of the image of the object.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a schematic overview of an imaging device.

FIG. 2 is an exemplary image showing an object having a distance to the imaging device.

FIG. 3 shows an exemplary graphics controller.

FIG. 4 shows a schematic diagram showing an imaging module in relation to an object being measured.

FIG. 5 shows a flowchart depicting an exemplary procedure for performing a range-finding operation using an imaging device.

### DETAILED DESCRIPTION

In the following description, numerous specific details are set forth in order to provide a thorough understanding of the present invention. However, it will be apparent to one skilled in the art that the present invention may be practiced without some of these specific details. In other instances, well known process operations and implementation details have not been described in detail in order to avoid unnecessarily obscuring the invention.

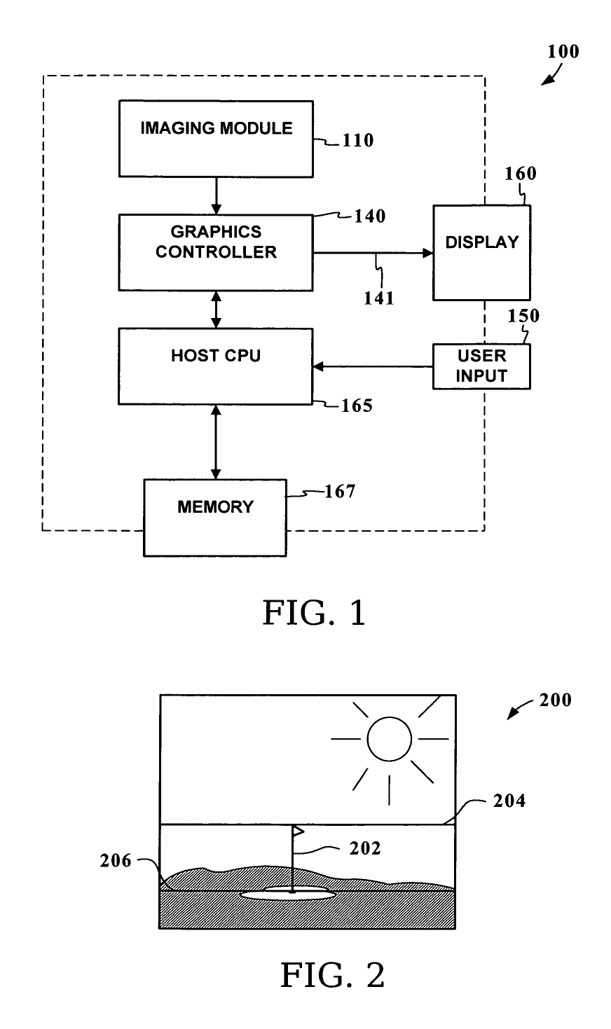

FIG. 1 is a schematic overview of an imaging device 100. Imaging device 100 may be a digital camera, digital video recorder, or some electronic device incorporating a image capture or video recorder functionality, such as, for example, a personal digital assistant (PDA), cell phone or other communications device. Imaging device 100 includes an imaging module 110, a graphics controller 140, a host central processing unit (CPU) 165, and a display 160.

The timing control signals and data lines, such as line 141 communicating between graphics controller 140 and display 160, are shown as a single line but may in fact be several address, data, and control lines and/or a bus. All communication lines shown in the figures will be presented in this manner except as noted to reduce the complexity and better present various novel aspects of imaging device 100.

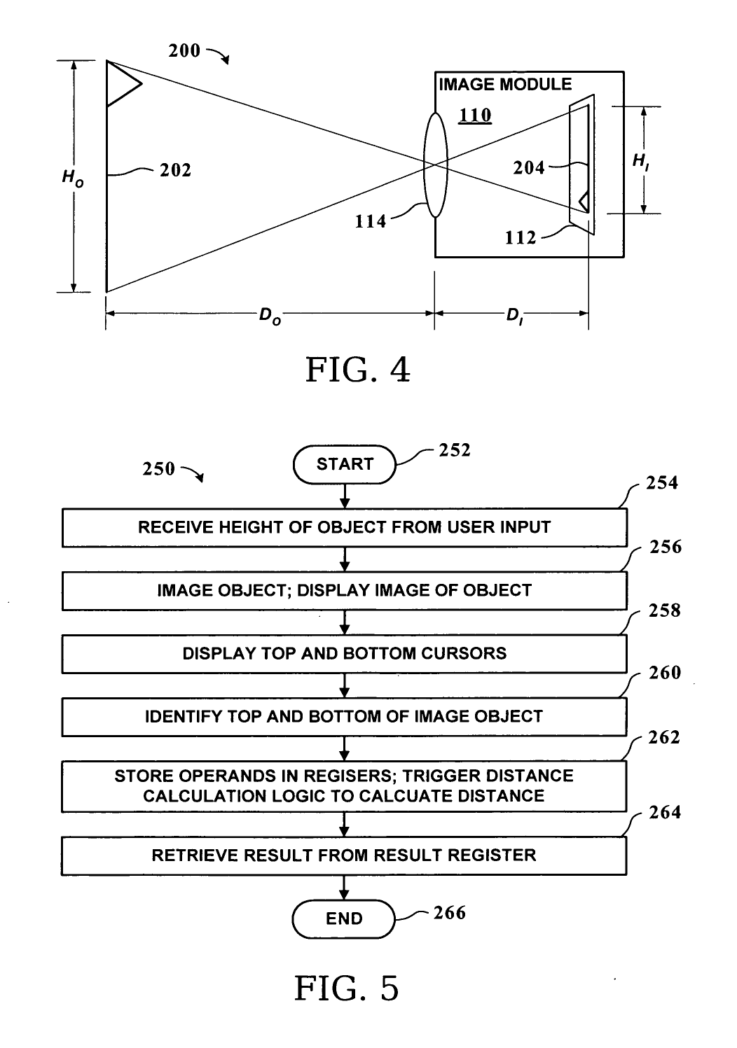

Imaging module 110 includes an image sensor positioned adjacent to a lens (as described below with reference to FIG. 4) such that light is focused on and forms an image on the sensor, and circuitry for reading out image data from the image sensor to graphics controller 140. The image sensor may be a charge-coupled device (CCD) or complementary metal-oxide semiconductor (CMOS) type image sensor that converts light into electronic signals that represent the level of light at each pixel. Other image sensors that are known or may become known that are capable of converting an image formed by light into electronic signals representative of the image may also be used. Imaging module 110 then converts these electronic signals into image data, which is passed to graphics controller 140. Imaging module 110 may have varying resolutions depending upon the application. In one embodiment, the image sensor comprises a two-dimensional array of pixel sensors in which each pixel sensor has a color filter in front of it in what is known as a color filter array (CFA). One common type of CFA is the Bayer filter in which every other pixel has a green filter over it in a checkerboard pattern, with remaining pixels in alternate rows having blue and red filters. Other types of color image sensors are available or may become available that are suitable for use with imaging device 100. In addition, the present invention may also be used with a gray-scale image sensor used for taking black and white (gray-scale) photographs.

Graphics controller 140 receives image data from imaging module 110, and, in accordance with instructions from host CPU 165, can send the image data to display 160 or host CPU 165. Graphics controller 140 may include image processing capabilities such as image compression technology for converting image data received from imaging module 110 into compressed image data, such as, for example, a Joint Photographic Exert Group (JPEG) format. Graphics controller 140 and other hardware devices incorporate logic typically designed using a hardware description language (HDL) or other means known to those skilled in the art of integrated circuit design. The generated circuits will include numerous logic gates and connectors to perform various operations and does not rely on software instructions.

Display 160 can be any form of display capable of displaying an image. In one embodiment, display 160 comprises a liquid crystal display (LCD). However, other types of displays are available or may become available that are capable of displaying a digital image that may be used in conjunction with imaging device 100.

Host CPU 165 performs digital processing operations and communicates with graphics controller 140. In one embodiment, host CPU 165 comprises an integrated circuit capable of executing firmware retrieved from memory 167. This firmware provides imaging device 100 with functionality when executed on host CPU 165. Host CPU may also be a digital signal processor (DSP) or other processing device.

Memory 167 may be internal or external random-access memory or non-volatile memory. Memory 167 may be non-removable memory such as flash memory or other EEPROM, or magnetic media. Alternatively, memory 167 may take the form of a removable memory card such as ones widely available and sold under such trademarks as “SD RAM,” “COMPACT FLASH,” and “MEMORY STICK.” Memory 167 may also be any other type of machine-readable removable or non-removable media. Memory 167 may be remote from imaging device 100. For example, memory may be connected to imaging device 100 via a communications port (not shown). For example, imaging device 100 may include a BLUETOOTH® interface or an IEEE 802.11 interface, commonly referred to as “Wi-Fi.” Such an interface may connect imaging device 100 with a host (not shown) for uploading image data to the host. If imaging device 100 is a communications device such as a cell phone, it may include a wireless communications link to a carrier, which may then store data in hard drives as a service to customers, or transmit image data to another cell phone or email address. Memory 167 may be a combination of memories. For example, memory 167 may include a removable memory card for storing image data, and a non-removable memory for storing data and firmware executed by host CPU 165.

Host CPU 165 is also in communication with user input device 150. In one embodiment, user input device 150 comprises a keypad. Alternatively, user input device 150 may comprise any number of alternate means, such as a joystick, a remote control, touch-screen, sound or voice activation, etc. User input device 150 may further include a mode selection dial or graphical interface buttons for selecting and/or manipulating items on display 160.

Imaging device 100 can operate in a picture taking mode and a range-finding mode. In the picture-taking mode, a photographer may save a single image by orienting imaging device 100 such that a desired image is aligned with the image sensor of imaging module 110. Graphics controller 140 then passes resulting image data to either or both of display 160 and host CPU 165 for storage in memory. Imaging module 110 and/or graphics controller 140 may include image processing circuitry for compressing the image using an image compression algorithm such as the well known JPEG image format. In one mode of operation, display 160 is continuously updated with an image most recently received by imaging module 110. When the user desires to send data representing a current image to memory 167, the user will interact with user input device 150 causing an image received by imaging module 110 to be passed to a frame buffer in graphics controller 140, from which host CPU 165 will access and store the image in memory 167. Instead of or in addition to taking single still images, imaging device 100 may be capable of generating a video stream. In this case, graphics controller 140 may receive an image periodically, e.g., 30 times a second, which is then encoded using Moving Picture Experts Group (MPEG) or other encoding technology and stored in memory 167.

In the range-finding mode, the user takes a picture of an object having a known size, e.g., height, but which is at an unknown distance. In one embodiment, the user enters the known height, or selects the object from a list of objects having known heights and then positions object-top and object-bottom cursors overlaying the image in the display. Once the object-top and object-bottom cursors are positioned, imaging device 100 can calculate the approximate distance to the object as described in further detail below. In another embodiment, the user identifies the width of the object by positioning object-left and object-right cursors.

FIG. 2 is an exemplary image 200 showing an object 202 having a distance to the imaging device that captured image 200. Imaging device 100 displays an object-top cursor 204 and an object-bottom cursor 206 which are repositionable via user input. Since the distance to the object relates to the size it appears in image 200, its distance can be calculated from the object's height (or width) in pixels.

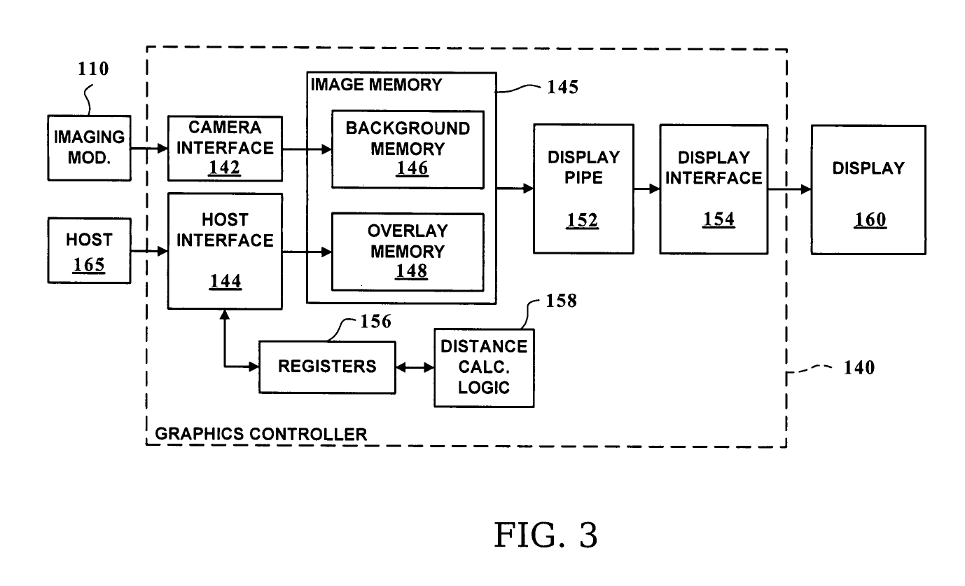

FIG. 3 shows an exemplary graphics controller 140. Graphics controller 140 includes a camera interface 142 in communication with imaging module 110. Camera interface 142 receives image data and stores it into image memory 145. In one embodiment, image memory 145 includes a background image memory 146 and an overlay image memory 148. Host interface 144, in communication with host CPU 165, is in communication with image memory 145 and allows host CPU 165 the capability of writing into the overlay memory 148. Display pipe 152 reads image data from background memory 146 and overlays image data from overlay memory 148 to create a composite image, which is passed to display interface 154. Display interface 154 interacts with display 160 in a known manner to cause the composite image to be displayed in display 160.

It should be noted that graphics controller 140 is capable of displaying background and overlay images from image memory 145 in real time, such that changes written to image memory 145 are reflected in real time on display 160. In the range-finding mode, a single image is captured and held in background memory 146 and the user is permitted to manipulate object-top and object-bottom cursors, which are drawn by host CPU 165 and displayed using overlay memory 148.

FIG. 4 shows a schematic diagram showing an exemplary imaging module 110 in relation to an object 202 being measured. Imaging module 110 includes an imaging surface 112 a distance D_{I} from a lens 114. Light reflected from object 202 is focused by lens 114 on imaging surface 204, which includes light sensor elements to translate the image into a digital representation thereof. The magnification of the camera lens is defined as the ratio of the image size H_{I} to the size of the actual object, H_{O}. If the image and the object are in the same medium, e.g., air, the magnification is also equal to the image distance D_{I} divided by the object distance D_{O}:
M=D_{I}/D_{O}=H_{I}/H_{O} [Eq. 1]

When the object distance is much greater than the image distance, the image distance equals the focal length. This is equivalent to setting the focus of a camera to infinity. For a standard 35 mm focal length camera lens, this approximation becomes very accurate even a few meters away. Thus we can solve Equation 1 for the distance to the object D_{O} and substitute the image distance D_{I} with the focal length f:
D_{O}=f*(H_{O}/H_{I}) [Eq. 2]

Therefore, by knowing the focal length of imaging device 110, the height of an object 202, and the height of the image of the object 204, then the distance to the object D_{O} can be calculated.

Returning to FIG. 3, graphics controller 140 also includes a plurality of registers 156 and distance calculation logic 158. In one embodiment, the host CPU can store the height of an object in an arbitrary unit of measurement, and the height of the object's image in pixels into registers 156. Distance calculation logic 158 updates a different register with the distance to the object in the same arbitrary units of measurement. Table 1 shows exemplary registers and descriptions therefore. The register H_{O} is the actual height of the object as entered by the user. In one embodiment, the user stores the height of the object prior to or during the range-finding operation by entering a value using a keypad portion of user interface 150 of FIG. 1. In another embodiment, the user can select an object from a list of objects whose heights are known to the device. In yet another embodiment, the user may enter an initial known distance to the object, take a picture of the object, identify the top and bottom of the object, and calculate the actual height of the object, which can then be stored in the H_{O} register. This can then be used at a later time when the user is at an unknown distance from the object. The H_{I} register reflects the size of the object as it appears in the display. As mentioned previously, widths can be used in place of heights. The unit multiplier can provide a conversion factor from the units of measurement of H_{O} and the units of measurement for D_{O}. For example, if H_{O} is measured in feet, and the user wants an output in terms of yards, then the unit multiplier can be set to ⅓, to convert feet to yards. Likewise, if H_{O} is measured in centimeters, but the user wants an output in terms of meters, then the unit multiplier can be set to 1/100, It will be understood by those skilled in the art that providing H_{I} in pixels is readily convertible to an actual height in another unit of measurement, since the pixel pitch in the image sensor is known.

TABLE 1
EXEMPLARY GRAPHICS CONTROLLER REGISTERS

| Register Name | Description |
|---|---|
| H_{O} | Height of object in arbitrary unit of measurement, as |
| | input by user |
| H_{I} | Height of the object in image, in pixels |
| unit-multiplier | A multiplier for output distance measurement |
| D_{O} | Distance to object as calculated by distance calculation |
| | logic |

It is possible to include other registers as well. For example, if the imaging device has zoom functionally, a register can be provided to reflect the current effective focal length.

FIG. 5 shows a flowchart 250 depicting an exemplary procedure for performing a range-finding operation using an imaging device. The procedure begins as indicated by start block 252 and proceeds to operation 254 wherein the height of the object is received from user input. In one embodiment, the user is asked to simply enter the height of the object in some unit of measurement, which may be selected by the user depending on implementation. In another embodiment, the user selects the object from a list of objects having known heights. The procedure then proceeds to operation 256, in which the user images the object, and the image is displayed on the display screen, e.g., as shown in FIG. 2.

Next, in operation 258, the top and bottom cursors are displayed as, for example, shown in FIG. 2. In one embodiment, one of the cursors may be highlighted by flashing or by being presented in a different color, such as red, to indicate it is the currently selected cursor. Initially, the object-top cursor is highlighted. The user then uses up and down buttons in the keypad to position the object-top cursor at the top of the object, presses “OK” or “Enter,” causing the object-bottom cursor to be highlighted, whereupon, the user can position the object-bottom cursor to indicate the bottom of the object. When appropriately positioned, the user can select “OK” or “Enter” again, causing the distance to the object to be calculated. If the object width is being measured instead of height, then left and right buttons on the keypad are used to position object-left and object-right cursors.

In operation 262, operands are written to registers 156 of display controller 140 and distance calculation logic 158 is triggered to calculate the distance to the object and store the result in one of registers 156 (FIG. 3). The operands include the actual height of the object, which was entered by a user and the height of the object image in pixels. The height of the object image is determinable by the distance between the object-top and object-bottom cursors. Any other registers such as a unit multiplier register, etc., as described above with reference to Table 1 are also loaded. Distance calculation logic 158 may be triggered by one of the registers being written to, or else a dedicated signal line from host interface 144 (not shown) may be provided. In operation 264, the result is retrieved by the host CPU and displayed for the user. The procedure can then end as indicated by end block 266.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated. Further, the manipulations performed are often referred to in terms such as producing, identifying, determining, or comparing.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for determining a distance to an object, the method comprising:
determining a size of the object;
generating an electronic image of the object by focusing an image of the object on an image sensor using an imaging module;
displaying an image of the object on a display device;
determining a size of the image of the object;
calculating the distance to the object using the size of the object, a focal length of the imaging module, and the size of the image of the object; and
displaying the distance to the object on the display device.

2. The method of claim 1, further comprising:
storing operands comprising the size of the object and the size of the image of the object in registers of a graphics controller device;
triggering distance calculation logic on the graphics controller device to calculate the distance to the object from the operands; and
retrieving the distance to the object from the registers of the graphics controller.

3. The method of claim 2, wherein the operands further comprise a units multiplier for converting units of measurement of the size of the object to units of measurements of the distance to the object.

4. The method of claim 2, wherein the imaging module includes an optical zoom mechanism, and the operands further include an effective focal length of the lens.

5. The method of claim 1, wherein the determining a size of the object comprises receiving user input from a user interface, the user input including the size of the object.

6. The method of claim 1, wherein the size of the object comprises a height of the object.

7. The method of claim 6 wherein the height of the image of the object is determined by user input, the user input comprising positioning of an object-top cursor at a top of the image of the object, and an object-bottom cursor at a bottom of the image of the object.

8. A graphics controller for calculating a distance to an object, the graphics controller comprising:
a camera interface receiving images from an imaging module;
a display interface for displaying an image on a display;
a host interface for interfacing with a host CPU;
a plurality of registers; and
distance calculation logic, the distance calculation logic calculating the distance to the object from operands stored in the plurality of registers and storing the distance to the object in one of the plurality of registers, the operands comprising a size of the object and a size of the image of the object.

9. The graphics controller of claim 8, further comprising an image memory comprising a background memory and an overlay memory, the background memory receiving image data from the camera interface and the overlay memory receiving overlay data from the host interface, the graphics controller further comprising a display pipe for generating a composite image formed by combining the overlay data with the image data.

10. The graphics controller of claim 8, wherein the operands further comprise a units multiplier for converting units of measurement of the size of the object to units of measurements for the distance to the object.

11. The graphics controller of claim 8, wherein the imaging module includes an optical zoom mechanism, and the operands further include an effective focal length of the optical zoom mechanism lens.

12. A device for determining a distance to an object, the device comprising:
an imaging module having a lens and an image sensor, the lens focusing an image onto the image sensor;
an electronic display for displaying an electronic image;
a user input device, the user input device;
a host CPU in communication with user input device; and
a graphics controller, the graphics controller comprising a camera interface receiving images from the imaging module, a display interface for displaying an image on the display, a host interface for interfacing with the host CPU, a plurality of registers, and distance calculation logic, the distance calculation logic calculating the distance to the object from operands stored in the plurality of registers and storing the distance to the object in one of the plurality of registers, the operands comprising a size of the object and a size of the image of the object.

13. The device of claim 12, wherein the graphics controller further comprises an image memory comprising a background memory and an overlay memory, the background memory receiving image data from the camera interface and the overlay memory receiving overlay data from the host interface, the graphics controller further comprising a display pipe for generating a composite image formed by combining the overlay data with the image data.

14. The device of claim 12, wherein the operands further comprise a units multiplier for converting units of measurement of the size of the object to units of measurements for the distance to the object.

15. The device of claim 12, wherein the imaging module includes an optical zoom mechanism, and the operands further include an effective focal length of the optical zoom mechanism lens.

16. The device of claim 12, wherein the host CPU retrieves software instructions from a memory device, the software instructions causing the host CPU to perform a distance measuring method comprising:
determining the size of the object;
generating an electronic image of the object by focusing an image of the object on an image sensor using the imaging module;
displaying an image of the object on the display device;
determining a size of the image of the object;
storing the operands the plurality of registers;
reading the distance to the object from the plurality of registers, and
displaying the distance to the object on the display device.

17. The device of claim 16, wherein the determining a size of the object comprises receiving user input from a user interface, the user input including the size of the object.

18. The method of claim 16, wherein the size of the object comprises a height of the object and wherein a height of the image of the object is determined by user input, the user input comprising positioning of an object-top cursor at a top of the image of the object, and an object-bottom cursor at a bottom of the image of the object.

19. The method of claim 16, further comprising using a host central processing unit (CPU) to carry out operations of the method, the host CPU executing program instructions stored on a computer readable medium.

20. The method of claim 19 wherein program instructions for determining the height of the image of the object comprise program instructions for accepting user input to position an object-top cursor at a top of the image of the object, and an object-bottom cursor at a bottom of the image of the object.
